(19) United States
(12) Patent Application Publication
(10) Pub. No.: US 2020/0061836 A1
(43) Pub. Date: Feb. 27, 2020

(54) LID-CLOSING APPARATUS AND LID-CLOSING METHOD

(71) Applicant: KAWASAKI JUKOGYO KABUSHIKI KAISHA, Kobe-shi, Hyogo (JP)

(72) Inventor: Kazunori HIRATA, Yao-shi (JP)

(73) Assignee: KAWASAKI JUKOGYO KABUSHIKI KAISHA, Kobe-shi, Hyogo (JP)

(21) Appl. No.: 16/500,438

(22) PCT Filed: Apr. 2, 2018
(86) PCT No.: PCT/JP2018/014086

§ 371 Date: Oct. 3, 2019

(30) Foreign Application Priority Data
Apr. 3, 2017 (JP) 2017-073833

(51) Int. Cl. B25J 9/16; B67B 6/00; B25J 11/00

(52) U.S. Cl. CPC B25J 9/1687; B25J 11/005; B25J 9/1612; B67B 6/00

(57) ABSTRACT

A lid tilted with a first end thereof facing downward in a gravity direction is brought into partial contact with a first end of a container body having an opening and a peripheral portion surrounding the opening, the first end of the container body being included in the peripheral portion and corresponding to the first end of the lid. The lid kept in partial contact with the first end of the peripheral portion of the container body is slid to a position where the first end of the lid is a contact portion at which the lid makes contact with the container body and where the first end of the lid is in contact with the first end of the peripheral portion of the container body. Thus, the container body is closed with the lid covering the opening of the container body.

### TECHNICAL FIELD

The present invention relates to a lid-closing apparatus that closes a container body with a lid and to a lid-closing method.

### BACKGROUND ART

Lid-closing apparatuses employing a robot to close a container body with a lid have been conventionally used. Such an apparatus employing a robot to close a container body with a lid is disclosed, for example, in Patent Literature 1, Patent Literature 1 discloses an apparatus configured to bring one end of an outer container member close to an inner container member, then detect the amount of displacement between the inner and outer container members by means of imaging, and cover the inner container member with the outer container member while making a correction for the displacement between the inner and outer container members and avoiding contact between the inner and outer container members.

### CITATION LIST

### Patent Literature

Patent Literature 1: Japanese Laid-Open Patent Application Publication No. 2008-080623

### SUMMARY OF INVENTION

### Technical Problem

The apparatus as disclosed in Patent Literature 1, which covers the inner container member with the outer container member, detects the amount of displacement between the inner and outer container members by means of imaging and performs the covering of the inner container member with the outer container member while making a correction for the displacement between the inner and outer container members. Thus, control of the movement of the arm in the operation of covering the inner container member with the outer container member is complicated and requires a high-performance control unit. This may cause an increase in manufacturing cost of the apparatus which covers the inner container member with the outer container member.

In view of the above circumstances, it is an object of the present invention to provide a lid-closing apparatus and a lid-closing method that allow simplified control.

### Solution to Problem

A lid-closing apparatus of the present invention includes: a lid holder configured to hold a lid and move the lid; and a control unit configured to control the holding and movement of the lid by the lid holder, wherein the control unit performs the control of the holding and movement of the lid by the lid holder in such a manner that: the lid holder holds the lid; the lid tilted with a first end thereof facing downward in a gravity direction is brought into partial contact with a first end of a container body having an opening and a peripheral portion surrounding the opening, the first end of the container body being included in the peripheral portion and corresponding to the first end of the lid; the lid kept in partial contact with the first end of the peripheral portion of the container body is slid to a position where the first end of the lid is a contact portion at which the lid makes contact with the container body and where the first end of the lid is in contact with the first end of the peripheral portion of the container body; and the container body is closed with the lid covering the opening of the container body.

With the lid-closing apparatus configured as described above, the operation of closing the container body with the lid includes bringing the tilted lid into contact with the peripheral portion surrounding the opening of the container body and sliding the lid to a position where the first end of the lid is the contact portion and is in contact with the first end of the peripheral portion of the container body. Thus, the peripheral portion of the container body can be used as a guide for the movement of the lid. Therefore, high precision is not required of the positioning of the lid to be moved, and control of the movement of the lid is easy. This allows simplification of the control structure for controlling the movement of the lid.

The control unit may cause the lid to be moved in such a manner that a second end of the lid comes into contact with a second end of the container body once the first end of the lid becomes the contact portion and comes into contact with the first end of the peripheral portion of the container body, the second end of the lid being opposite to the first end of the lid, the second end of the container body being included in the peripheral portion and corresponding to the second end of the lid.

The lid holder may include a holding portion configured to hold a lid and a rotation shaft configured to allow the holding portion to rotate, and the lid holder may be configured to cause the holding portion holding the lid to rotate about the rotation shaft and thereby cause the lid to rotate about the rotation shaft.

Since the lid held by the holding portion of the lid holder can be rotated about the rotation shaft, the posture of the lid can be smoothly changed from the tilted posture to a posture in which the lid is placed over the container body.

The control unit may cause the lid covering the opening of the container body to be moved toward the container body.

With the configuration in which the lid covering the opening of the container body is moved toward the container body, the lid can be tightly fitted on the container body.

The lid-closing apparatus may further include a container body holder configured to hold the container body and move the container body, and the control unit may control the holding and movement of the container body by the container body holder.

The container body holder may be configured to press the lid covering the opening of the container body against the container body.

The container body holder may include a chuck portion including a first member and a second member, the first and second members being configured to move closer to each other, and the chuck portion may be configured to grip a part of the container body between the first and second members and configured to press the lid covering the opening of the container body against the container body by griping a part of the lid and a part of the container body together.

Since the container body holder is configured to perform both the gripping of the container body and the pressing of the lid against the container body, the size of the apparatus can be reduced, and the manufacturing cost of the apparatus can also be reduced.

The lid holder may be configured as a component of a robotic arm.

The container body holder may be configured as a component of a robotic arm.

A lid-closing method of the present invention is a lid-closing method for placing a lid in a position where the lid covers an opening of a container body and closing the container body with the lid, the lid-closing method including: a contacting step of bringing the lid tilted with a first end thereof facing downward in a gravity direction into partial contact with a first end of the container body, the first end of the container body being included in a peripheral portion surrounding the opening, the first end of the container body corresponding to the first end of the lid; and a sliding step of sliding the lid kept in partial contact with the first end of the peripheral portion of the container body to a position where the first end of the lid is a contact portion at which the lid makes contact with the container body and where the first end of the lid is in contact with the first end of the peripheral portion of the container body.

With the lid-closing method configured as described above, the operation of closing the container body with the lid includes bringing the tilted lid into contact with the peripheral portion surrounding the opening of the container—body and sliding the lid to a position where the first end of the lid is the contact portion and is in contact with the first end of the peripheral portion of the container body. Thus, the peripheral portion of the container body can be used as a guide for the movement of the lid. Therefore, high precision is not required of the positioning of the lid to be moved, and control of the movement of the lid is easy. This allows simplification of the control structure for controlling the movement of the lid.

### Advantageous Effects of Invention

According to the present invention, the operation of closing a container body with a lid can he accomplished by simplified control: Thus, the control unit responsible for control of arms does not need to have high performance, and an increase in the cost required for the control unit can be prevented. This can result in a reduction in the manufacturing cost of the lid-closing apparatus,

### BRIEF DESCRIPTION OF DRAWINGS

FIG. 1 is a perspective view of a lid-closing apparatus according to an embodiment of the present invention.

FIG. 2 is a front view of a lid-closing apparatus main body of the lid-closing apparatus of FIG. 1.

FIG. 3 is a block diagram showing the configuration of a control system of the lid-closing apparatus of FIG. 1.

FIG. 4 is a flowchart illustrating the workflow of the lid-closing operation performed by the lid-closing apparatus of FIG. 1.

FIG. 5 is a perspective view of the lid-closing apparatus of FIG. 1 in which a container body holder of a lid-closing apparatus main body grips a container body.

FIG. 6 is a perspective view of the lid-closing apparatus of FIG. 1 in which the container body holder of the lid-closing apparatus main body has moved the container body to a lid-closing space.

FIG. 7 is a perspective view of the lid-closing apparatus of FIG. 1 in which a lid holder of the lid-closing apparatus main body has brought a lid close to the container body.

FIG. 8 is a perspective view of the lid-closing apparatus of FIG. 1 in which the lid holder of the lid-closing apparatus main body has brought the lid into contact with the container body.

FIG. 9 is a perspective view of the lid-closing apparatus of FIG. 1 in which the lid holder of the lid-closing apparatus main body is moving the lid by sliding it along a peripheral portion of the container body.

FIG. 10 is a perspective view of the lid-closing apparatus of FIG. 1 in which the lid holder of the lid-closing apparatus main body has moved the lid to a position where the lid covers the opening of the container body.

FIG. 11 is a perspective view of the lid-closing apparatus of FIG. 1 in which the container body holder and the lid holder of the lid-closing apparatus main body have moved away from the container body and lid after the lid-closing operation.

FIG. 12 is a perspective view of the lid-closing apparatus of FIG. 1 in which the container body holder is pushing the container body and lid subjected to the lid-closing operation while gripping and moving another container body to be subjected to the next lid-closing operation.

FIG. 13 is a perspective view of the lid-closing apparatus of FIG. 1 in which the container body holder has removed the container body and lid subjected to the lid-closing operation from the lid-closing space and has moved another container body to be subjected to the next lid-closing operation to the lid-closing space.

### DESCRIPTION OF EMBODIMENTS

Hereinafter, a lid-closing apparatus and a lid-closing method according to an embodiment of the present invention will be described with reference to the accompanying drawings.

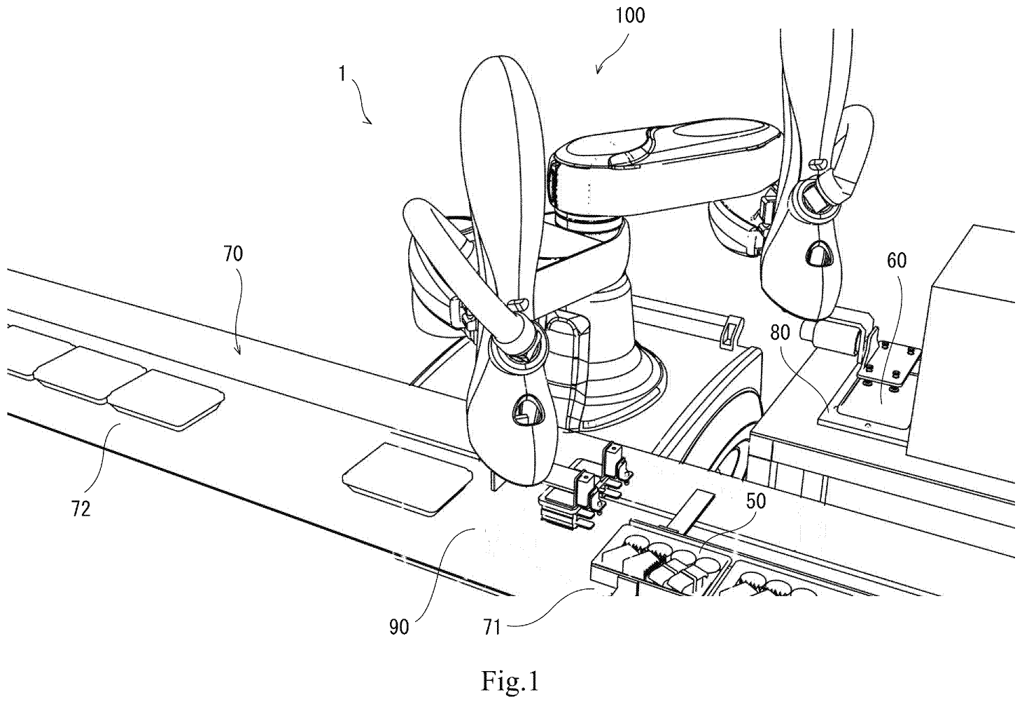

FIG. 1 shows the configuration of a lid-closing apparatus according to an embodiment of the present invention. As shown, in FIG. 1, a lid-closing apparatus 1 includes a lid-closing apparatus main body 100, a belt conveyor 70 on which container bodies 50 are conveyed, a lid support base 80 on which lids 60 are placed, and a lid-closing space 90 in which lid-closing is performed. The lid-closing operation of putting the lid 60 over the container body 50 is performed with the container body 50 being placed in the lid-closing space 90.

The belt conveyor 70 includes an upstream belt conveyor 71 and a downstream belt conveyor 72. The upstream belt conveyor 71 is provided upstream of the lid-closing space 90 and conveys the container bodies 50 to the vicinity of the lid-closing space 90. The downstream belt conveyor 72 is provided downstream of the lid-closing space 90 and conveys the container bodies and lids subjected to the lid-closing operation downstream from the lid-closing space 90. That is, the container body 50 is conveyed to the lid-closing space 90 by the upstream belt conveyor 71, then the lid 60 is put over the container body 50 to close the container body 50 with the lid and, after that, the lidded container body 50 is conveyed downstream from the lid-closing space 90 by the downstream belt conveyor 72.

In the present embodiment, the container body 50 is packed with food; namely, the container body 50 is used as a lunch container. The container body 50 has an opening. The product to be contained is placed into the container body 50 through the opening. The product contained in the container body 50 is not limited to food. A product other than food may be contained in the container body 50. The contained product may be of any kind.

In the present embodiment, the opening of the container body 50 faces upward. The lid 60 and the container body 50 are configured so that the operation of closing the container body 50 with the lid 60 is performed by placing the lid 60 onto the container body 50 from above and covering the opening of the container body 50 with the lid 60. The lid 60 is formed to be larger than the opening of the container body 50 so that the lid 60 can cover the opening. Once the lid-closing operation is performed and the lid 60 is placed on the container body 50 so as to cover the opening of the container body 50, the opening of the container body 50 is closed with the lid 60 covering the entire opening.

On the lid support base 80 are placed the lids 60 with which the container bodies 50 are closed. A lid holder described later holds the lid 60 placed on the lid support base 80 and places the lid 60 in a position where the lid 60 covers the opening of the container body 50 in this manner, the operation of closing the container body 50 with the lid is performed.

Next, the configuration of the lid-closing apparatus main body 100 will be described.

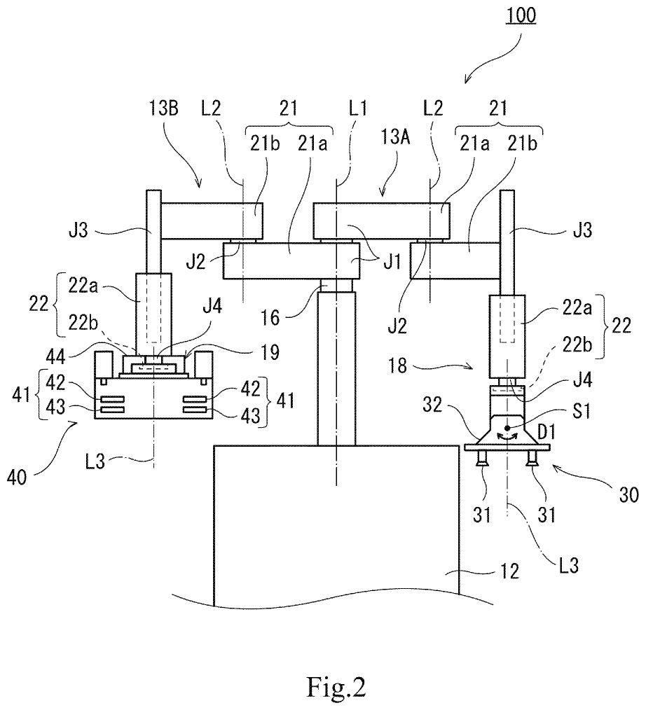

FIG. 2 is a front view of the lid-closing apparatus main body 100 of the present embodiment. As shown in FIG. 2, the lid-closing apparatus main body 100 is configured as a horizontal articulated dual-arm robot including a pair of robotic arms 13.

The lid-closing apparatus main body 100 includes a first robotic arm 13A and a second robotic arm 13B. A first holder 18 is provided at a distal end of the first robotic arm 13A. A second holder 19 is provided at a distal end of the second robotic arm 13B. In the following description, the first robotic arm 13A and the second robotic arm 13B may each be simply referred to as a robotic arm 13 when the arms 13A and 13b do not need to be distinguished from each other.

The lid-closing apparatus main body 100 includes a control unit and a vacuum generator (not illustrated in the drawings).

The control unit 14 is provided, for example, inside a support base 12 of the lid-closing apparatus main body 100. However, this is not limiting and, for example, the control unit 14 may be provided inside the robotic arm 13. Alternatively, the control unit 14 may be provided in any other unoccupied space.

Examples of the vacuum generator include a vacuum pump and CONVUM (registered trademark). As with the control unit 14, the vacuum generator is provided, for example, inside the support base 12. However, this is not limiting and, for example, the vacuum generator may be provided at any other location such as inside the robotic arm 13. The vacuum generator is connected to suction nozzles 31 of a lid holder 30 described later via an unillustrated pipe. The pipe is provided, for example, with an unillustrated on-off valve, and the on-off valve acts to open and close the pipe. The operation of the vacuum generator and the opening and closing of the on-off valve are controlled by the control unit.

The first robotic aim 13A moves the first holder 18 within a predefined movement range. The second robotic arm 13B moves the second holder 19 within a predefined movement range. Each robotic arm 13 is, for example, a horizontal articulated robotic arm, and includes an arm portion 21 and a wrist portion 22. The first robotic arm 13A and the second robotic arm 13B can operate both independently of, and in conjunction with, each other.

The first holder 18 and the second holder 19 are each configured to hold a hand portion having a specified function.

The lid-closing apparatus main body 100 includes the support base 12 and a base shaft 16 extending vertically upward from the support base 12. The base shaft 16 is rotatably mounted to the support base 12.

To the base shaft 16 are mounted the arm portions 21, which extend horizontally. Each arm portion 21 is mounted to be rotatable about the base shaft 16.

Each aim portion 21 includes a first link 21a and a second link 21b. The first link 21a and the second link 21b are supported to be rotatable relative to each other in a horizontal plane. The first robotic arm 13A and the second robotic arm 13B are connected to the base shaft 16 via the arm portions 21.

The arm portions 21 place the wrist portions 22, which are attached at the respective distal ends of the first and second robotic arms 13A and 13B, to desired positions within the movement ranges.

The first link 21a has a proximal end coupled to the base shaft 16 of the support base 12 by a rotating joint J1 and is rotatable about a rotation axis L1 passing through the center of the base shaft 16. The second link 21b is coupled to a distal end of the first link 21a by a rotating joint J2 and is rotatable about a rotation axis L2 defined by the distal end of the first link 21a.

A mechanism is connected to the distal end of each wrist portion 22, and the wrist portion 22 changes the posture of the connected mechanism to a desired posture. The wrist portion 22 includes a raisable/lowerable portion 22a and a pivotable portion 22b. The raisable/lowerable portion 22a is coupled to the distal end of the second link 21b by a prismatic joint J3 and can be raised and lowered relative to the second link 21b. The pivotable portion 22b is coupled to a lower end of the raisable/lowerable portion 22a by a rotating joint J4 and is pivotable about a rotation axis L3 defined by the lower end of the raisable/lowerable portion 22a.

In the present embodiment, the rotation axes L1 to L3 are parallel to each other and, for example, extend vertically. The direction in which the rotation axes L1 to L3 extend and the direction in which the raisable/lowerable portion 22a is raised and lowered are parallel to each other.

Each arm 13 is provided with actuating servomotors (not illustrated) respectively associated with the joints J1 to J4 and is provided also with encoders (not illustrated) that detect the respective rotation angles of the servomotors. The rotation axis L1 in the first robotic arm 13A and the rotation axis L1 in the second robotic arm 13B lie on the same straight line, and the first link 21a of the first robotic arm 13A and the first link 21a of the second robotic arm 13B are located at different heights in the vertical direction.

Next, the hand portions that can be held by the first and second holders 18 and 19 will be described. In the present embodiment, the hand portion held by the first holder 18 is the lid holder 30. The hand portion held by the second holder 19 is a container body holder 40.

The lid holder 30 will be described first. The lid holder 30 is provided with a plurality of suction nozzles 31. The suction nozzles 31 project downward in the gravity direction.

Each suction nozzle 31 of the lid holder 30 is connected to the vacuum generator via the pipe described above, and air can be sucked through the suction nozzles 31. With this configuration, the lid 60 can be sucked and held on the tips of the suction nozzles 31 of the lid holder 30 by sucking air through the suction nozzles 31 and bringing the lid 60 into contact with the suction nozzles 31. The lid holder 30 is held by the first holder 18 and is configured to be movable in a predefined movement range upon actuation of the first robotic arm 13A.

The lid holder 30 includes a rotation shaft S1 and is configured to allow a holding portion 32 including the suction nozzles 31 to rotate in a direction D1 about the rotation shaft S Since the lid holder 30 includes the rotation shaft S1, the lid 60 can be rotated about the rotation shaft S1 by rotating the holding portion 32 about the rotation shaft S1 while the lid holder 30 holds the lid 60. In the present embodiment, the holding portion 32 of the lid holder 30 is configured to be rotatable about the rotation shaft S1 relative to the wrist portion 22 of the first robotic arm 13A.

Next, the container body holder 40 will be described. The container body holder 40 is provided with two chuck portions 41. Each of the two chuck portions 41 includes two upper and lower claw members (first member and second member) 42 and 43 arranged in the vertical direction. The chuck portion 41 is configured to grip and hold an object between the first and second claw members 42 and 43 by moving the first claw member 42 closer to the second claw member 43. The container body holder 40 is provided with a plate member 44 for pushing the container body 50 and the lid 60 toward the downstream belt conveyor 72 after completion of the lid-closing operation. The container body holder 40 is held by the second holder 19 and is configured to be movable in a predefined movement range upon actuation of the second robotic arm 13B.

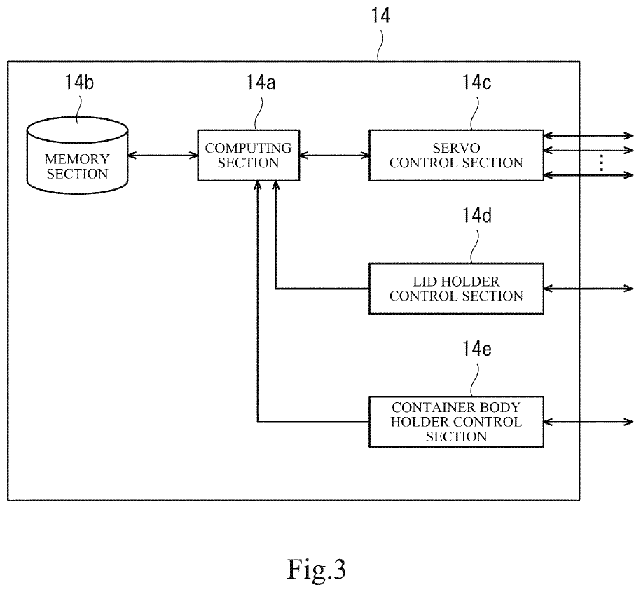

Next, the control unit 14 that controls the operation of the lid-closing apparatus main body 100 will be described. FIG. 3 is a block diagram schematically showing an exemplary configuration of the control system of the lid-closing apparatus main body 100.

As shown in FIG. 3, the control unit 14 includes a computing section 14a, a memory section 14b, a servo control section 14c, a lid holder control section 14d, and a container body holder control section 14e.

The control unit 14 is a robot controller equipped with a computer such as a microcontroller. The control unit 14 may consist of a single control unit 14 that performs centralized control or may include a plurality of control units 14 that cooperate together to perform distributed control.

The memory section 14b stores information such as a basic program for the robot controller and various fixed data. The computing section 14a retrieves and executes software such as the basic program stored in the memory section 14b to control various operations performed by the lid-closing apparatus main body 100. That is, the computing section 14a generates control commands for the lid-closing apparatus main body 100 and outputs the control commands to the servo control section 14c, the lid holder control section 14d, and the container body holder control section 14e.

The servo control section 14c is configured to, based on a control command generated by the computing section 14a, control the actuation of the servomotors associated with the joints J1 to 94 of each of the first and second robotic arms 13A and 13B of the lid-closing apparatus main body 100.

The lid holder control section 14d controls the vacuum generator and an actuator therefor based on a control command generated by the computing section 14a and thereby controls suction, movement, and any other operation performed by the lid holder 30.

The container body holder control section 14e controls an actuator for the container body holder 40 based on a control command generated by the computing section 14a and thereby controls holding performed by the chuck portions 41 of the container body holder 40 as well as movement and any other operation performed by the container body holder 40,

The following describes the operation that the lid-closing apparatus 1 configured as described above performs when closing the container body 50 with the lid 60 by placing the lid 60 onto the container body 50 in such a manner that the lid 60 covers the opening of the container body 50.

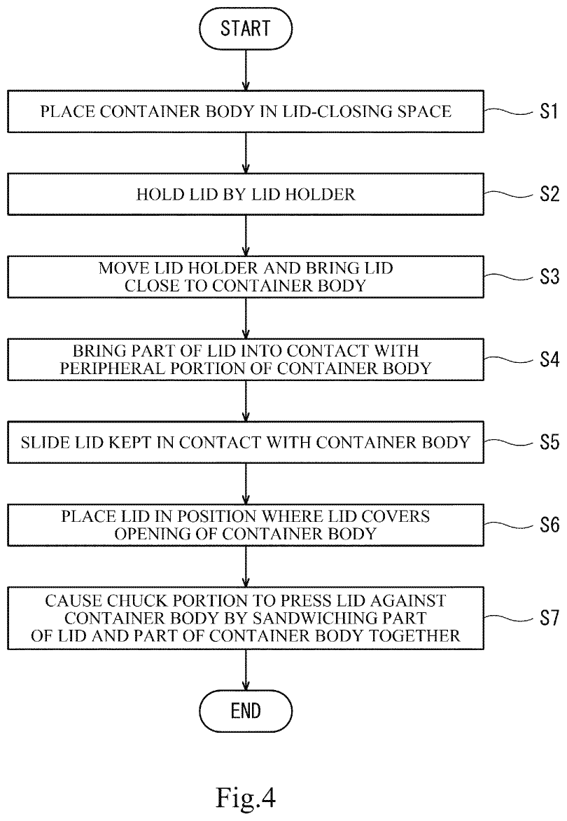

FIG. 4 is a flowchart illustrating the operation that the lid-closing apparatus 1 performs when closing the container body 50 with the lid 60 by placing the lid 60 in a position where the lid 60 covers the opening of the container body 50. Hereinafter, the steps performed to close the container body 50 with the lid 60 will be described with reference to the flowchart of FIG. 4.

First, the container body 50 is moved toward the lid-closing space 90, and the container body 50 is placed in the lid-closing space 90 (S1). Before being placed in the lid-closing space 90, the container body 50 is conveyed by the upstream belt conveyor 71 to the vicinity of the lid-closing space 90.

Once the container body 50 is conveyed to the vicinity of the lid-closing space 90, the chuck portions 41 of the container body holder 40 of the lid-closing apparatus main body 100 move to a position where the chuck portions 41 can grip a part of the container body 50.

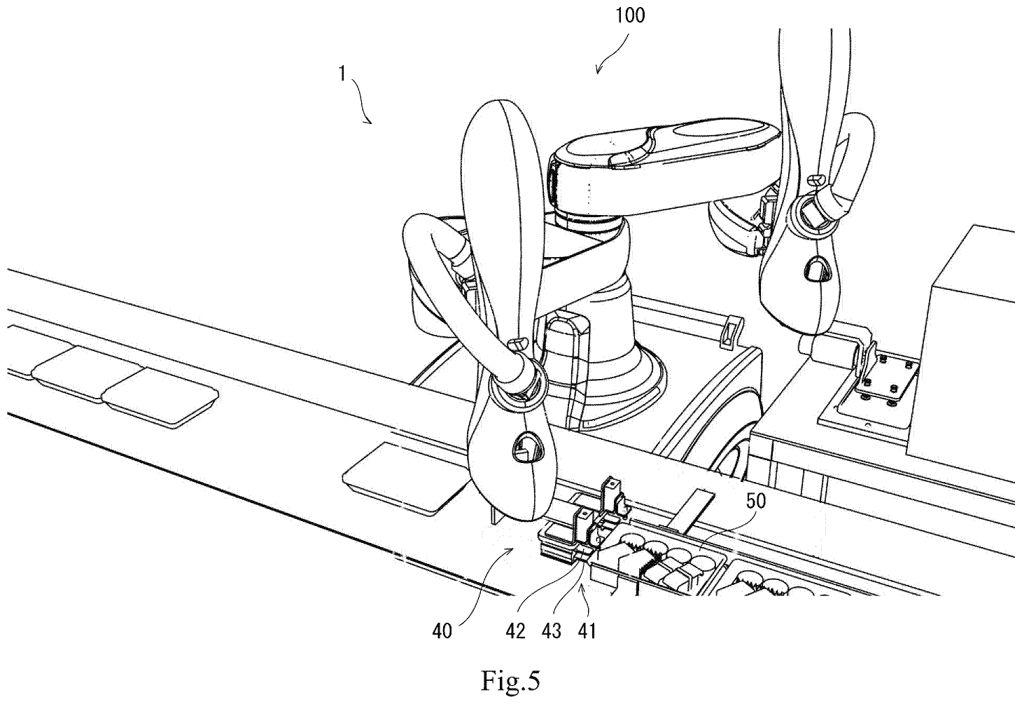

FIG. 5 is a perspective view of the lid-closing apparatus 1 in which a part of the container body 50 is gripped between the first and second claw members 42 and 43 of each chuck portion 41 of the container body holder 40. As shown in FIG. 5, once the chuck portions 41 grip a part of the container body 50, the container body holder 40 moves toward the lid-closing space 90 with the container body 50 being gripped by the chuck portions 41, and thus moves the container body 50 to the lid-closing space 90. In the present embodiment, during the movement of the container body 50, the container body holder 40 holds the container body 50 by gripping the downstream end of the container body 50 in the conveying direction.

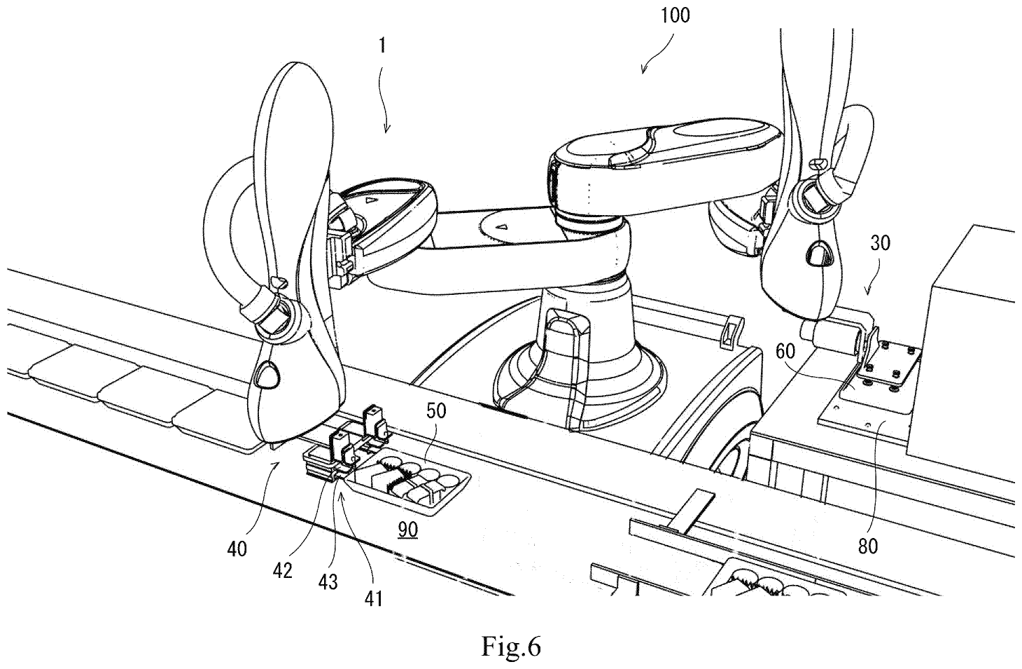

FIG. 6 is a perspective view of the lid-closing apparatus 1 in which the container body 50 has been moved to the lid-closing space 90. As described above, the container body holder 40 holding the container body 50 moves to the lid-closing space 90, and thus the container body 50 is moved to the lid-closing space 90.

Once the container body 50 is moved to the lid-closing space 90, the lid holder 30 holds the lid 60 placed on the lid support base 80 (S2). The holding of the lid 60 by the lid holder 30 may take place simultaneously with the movement of the container body 50 by the container body holder 40. In the present embodiment, as shown in FIG. 6, the lid holder 30 is in contact with and holds the lid 60 at the moment when the container body 50 has been moved to the lid-closing space 90 by the container body holder 40. In the present embodiment, air is sucked through the suction nozzles 31 of the lid holder 30, and thus the lid 60 is held by suction on the suction nozzles 31.

Once the lid holder 30 holds the lid 60, the lid holder 30 is moved to bring the lid 60 close to the container body 50 (S3).

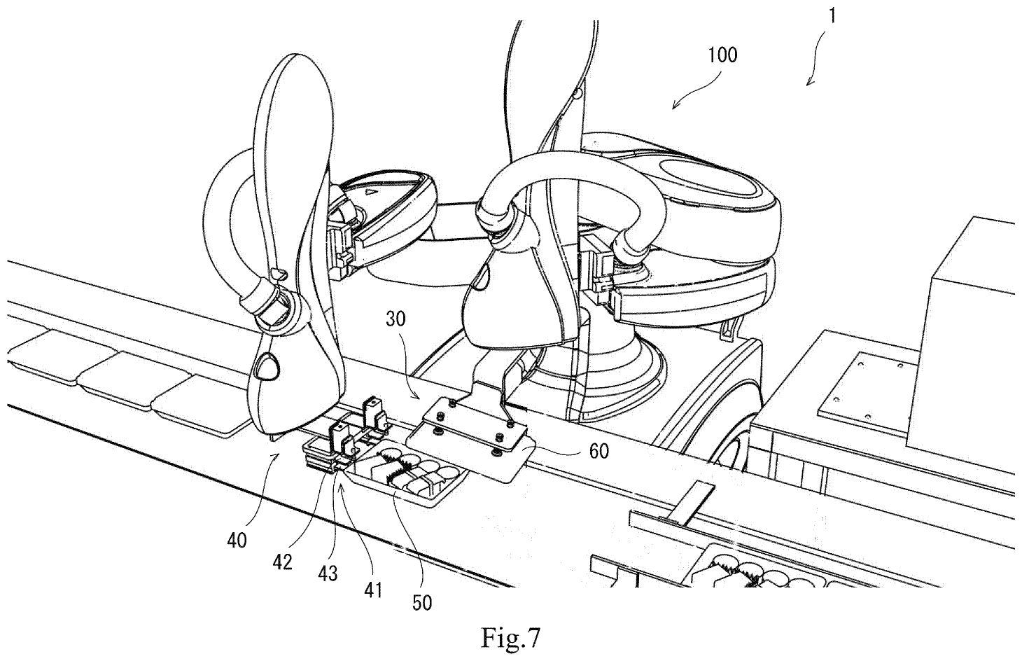

FIG. 7 is a perspective view of the lid-closing apparatus 1 in which the lid 60 has been brought close to the container body 50. When the lid 60 is brought close to the container body 50 in S3, the lid 60 is moved until the lid 60 comes into partial contact with a peripheral portion of the container body 50, the peripheral portion surrounding the opening.

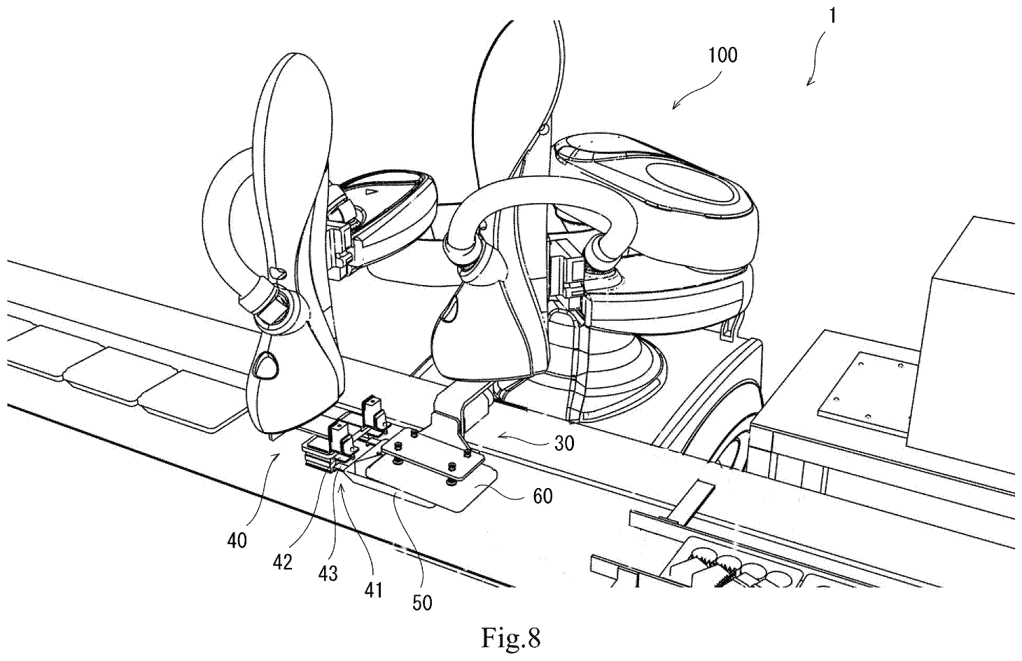

FIG. 8 is a perspective view of the lid-closing apparatus 1 in which the lid 60 has been brought into partial contact with the peripheral portion surrounding the opening of the container body 50.

When the lid 60 is brought into partial contact with the peripheral portion surrounding the opening of the container body 50, the lid 60 is tilted with a first end thereof facing downward in the gravity direction, and the tilted lid 60 is brought into contact with the peripheral portion of the container body 50 (contacting step). Specifically, the lid 60 is brought into contact with a first end of the container body 50, the first end corresponding to that first end of the tilted lid 60 which faces downward in the gravity direction. The term “first end”, as used, for example, to describe the lid-closing apparatus 1 shown in FIG. 8, refers to an end located upstream in the direction in which the container body 50 is conveyed by the belt conveyor 70. That is, the lid 60 is brought into partial contact with the upstream end of the peripheral portion of the container body 50 in the conveying direction of the container body 50.

As described above, when the lid 60 is brought into contact with the container body 50, the tilted lid 60 is brought into partial contact with the first end of the container body 50 which is included in the peripheral portion surrounding the opening of the container body 50 and which corresponds to the first end of the lid 60.

As shown in FIG. 8, once the lid 60 is brought into partial contact with the peripheral portion surrounding the opening of the container body 50, the lid holder 30 and therefore the lid 60 are moved while a part of the lid 60 and the peripheral portion of the container body 50 are kept in contact. Since a part of the lid 60 and the peripheral portion of the container body 50 are kept in contact during the movement of the lid 60, the lid 60 can be moved along the peripheral portion of the container body 50 using the peripheral portion of the container body 50 as a guide. In this manner, the lid 60 is slid while being kept in partial contact with the first end of the peripheral portion of the container body 50 (sliding step).

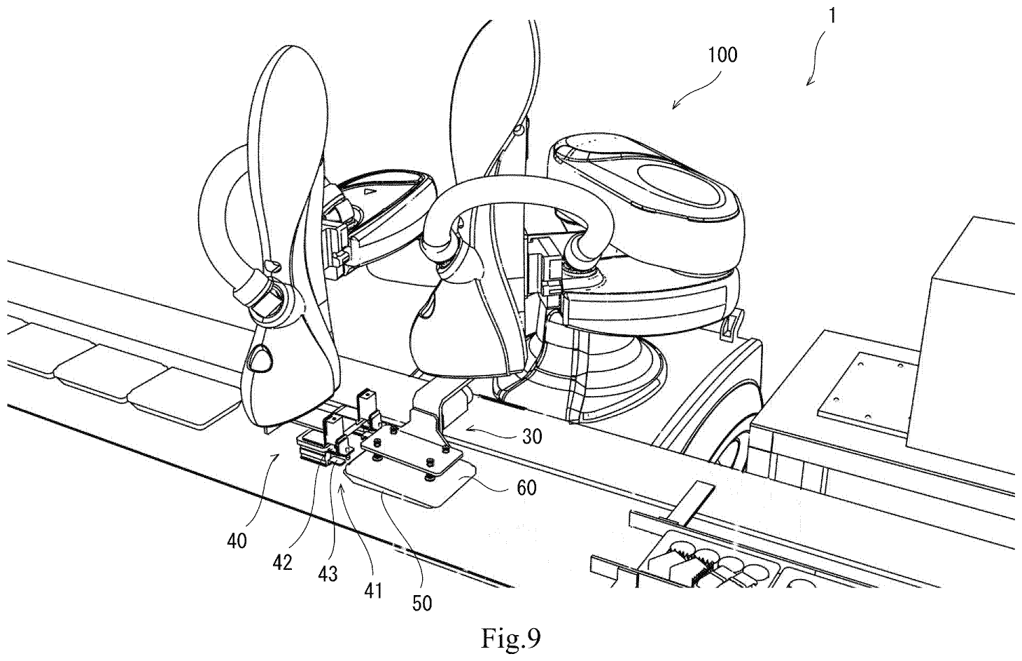

FIG. 9 is a perspective view of the lid-closing apparatus 1 in which the lid 60 is slid along the peripheral portion of the container body 50 while being kept in contact with the container body 50. The movement of the lid 60 along the peripheral portion of the container body 50 is performed while a part of the lid 60 and the peripheral portion of the container body 50 are kept in contact; that is, the movement of the lid 60 is performed by sliding the lid 60 on the peripheral portion of the container body 50 using the peripheral portion of the container body 50 as a guide (S5). The movement of the lid 60 along the peripheral portion of the container body 50 is performed until the lid 60 reaches a position where the lid 60 covers the opening of the container body 50. In other words, the movement of the lid 60 is performed until the lid 60 reaches a position where the first end of the lid 60 is a contact portion at which the lid 60 makes contact with the container body 50 and where the first end of the lid 60 is in contact with the first end of the peripheral portion of the container body 50.

During this movement, the point of contact of the lid 60 with the peripheral portion of the container body 50 does not remain the same. The point of contact of the lid 60 with the container body 50 is shifted. The lid 60 moves toward the position where the lid 60 covers the opening of the container body 50 while shifting the point of contact with the container body 50. The point of contact of the lid 60 with the container body 50 is shifted from the point where the lid 60 is brought into partial contact with the peripheral portion of the container body 50 in the contacting step of S4 toward the point where the first end of the lid 60 is a contact portion at which the lid 60 makes contact with the peripheral portion of the container body 50.

During the above movement, since the lid holder 30 includes the rotation shaft S1 and the holding portion 32 of the lid holder 30 is configured to be rotatable about the rotation shaft S1, the posture of the lid 60 held by the lid holder 30 can be smoothly changed from the tilted posture to a posture in which the lid 60 is placed over the container body 50. The lid 60 can move smoothly while changing its posture.

At the moment when the lid 60 reaches the position where the lid 60 covers the opening of the container body 50, an end of the lid 60 becomes a contact portion at which the lid 60 makes contact with the peripheral portion of the container body 50, and that end of the lid 60 comes into contact with an end of the container body 50, the end of the container body 50 being included in the peripheral portion (S6). That is, the sliding movement of the lid 60 along the peripheral portion of the container body 50 is performed with the lid 60 kept in contact with the container body 50 until the lid 60 reaches a position where the first end of the lid 60 is a contact portion at which the lid 60 makes contact with the container body 50 and where the first end of the lid 60 is in contact with the first end of the peripheral portion of the container body 50.

At the moment when the first end of the lid 60 becomes the contact portion and comes into contact with the first end of the peripheral portion of the container body 50, the point of contact of the lid 60 with the container body 50 is at the first end of the lid 60. That is, during the movement of the lid 60, the point of contact of the lid 60 with the container body 50 is shifted from the point where the lid 60 is brought into partial contact with the peripheral portion of the container body 50 in the contacting step of S4 to the point where the first end of the lid 60 is a portion at which the lid 60 makes contact with the container body 50.

in the present embodiment, once the first end of the lid 60 becomes the contact portion and comes into contact with the first end of the peripheral portion of the container body 50, a second end of the lid 60 comes into contact with a second end of the container body 50, the second end of the lid 60 being opposite to the first end of the lid 60, the second end of the container body 50 being included in the peripheral portion and opposite to the first end of the peripheral portion. The term “second end”, as used, for example, to describe the lid-closing apparatus 1 shown in FIG. 9, refers to an end located downstream in the direction in which the container body 50 is conveyed by the belt conveyor 70. That is, the downstream end of the contact portion of the lid 60 in the conveying direction of the container body 50 comes into contact with the downstream end of the peripheral portion of the container body 50 in the conveying direction of the container body 50. Thus, the second end of the lid 60, which is opposite to the first end of the lid 60, comes into contact with the second end of the peripheral portion of the container body 50. The second end of the container body 50 corresponds to the second end of the lid 60.

Once the first end of the lid 60 becomes the contact portion and comes into contact with the first end of the peripheral portion of the container body 50 and the second end of the lid 60 comes into contact with the second end of the peripheral portion of the container body 50, the lid 60 is placed in a position where the lid 60 covers the opening of the container body 50.

Once the ends of the lid 60 and the ends of the peripheral portion of the container body 50 come into contact, the lid 60 covering the opening of the container body 50 is moved toward the container body 50. In the present embodiment, a part of the lid 60 and a part of the container body 50 are gripped together by the chuck portions 41. The claw member 42 and the claw member 43 of each chuck portion 41 move closer to each other, with a part of the lid 60 and a part of the container body 50 being gripped together by the chuck portions 41. As a result, a part of the lid 60 covering the opening of the container body 50 and a part of the container body 50 are pressed against each other by the chuck portions 41, and the lid 60 is pressed against the container body 50 (S7). Thus, the container body holder 40 is configured to press the lid 60 covering the opening of the container body SC) against the container body 50.

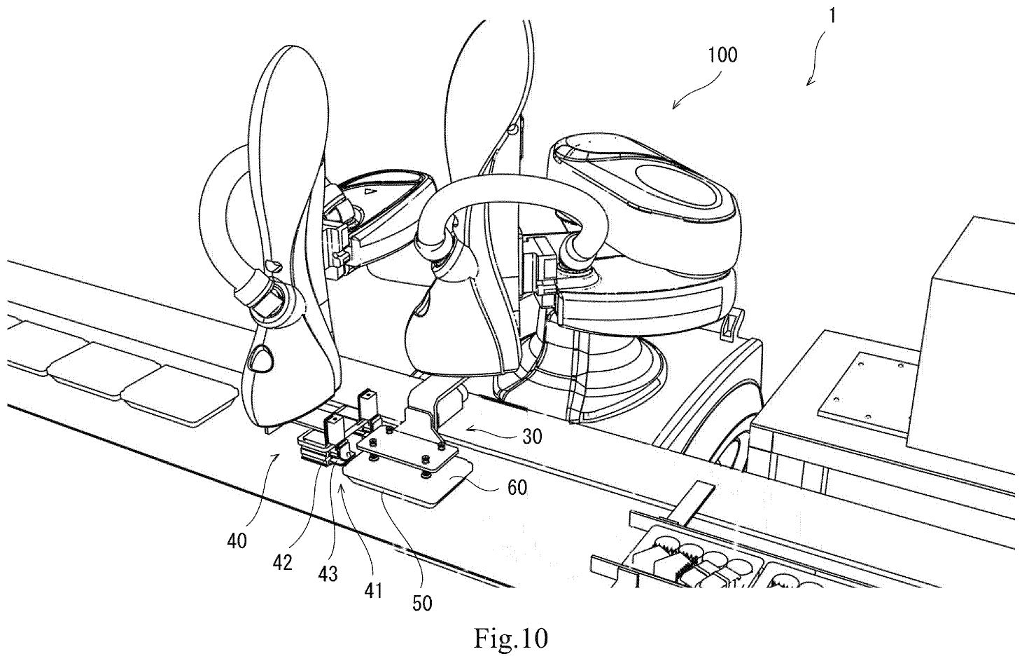

FIG. 10 is a perspective view of the lid-closing apparatus 1 in which a part of the lid 60 and a part of the container body 50 are gripped together by the chuck portions 41 and hence the lid 60 is pressed against the container body 50. As shown in FIG. 10, each chuck portion 41 includes the first claw member 42 and the second claw member 43, and the first claw member 42 and the second claw member 43 move closer to each other.

In the present embodiment, when pressing the lid 60 against the container body 50, each chuck portion 41 grips the second end (the downstream end in the conveying direction of the container body 50) of the lid 60 between the first and second claw members 42 and 43. Additionally, when pressing the lid 60 against the container body 50, each chuck portion 41 grips the second end of the container body 50 between the first and second claw members 42 and 43. That is, each chuck portion 41 of the container body holder 40, when pressing the lid 60 against the container body 50, grips the second end of the lid 60 and the second end of the container body 50 together between the first and second claw members 42 and 43.

As described above, each chuck portion 41 is configured to press the lid 60 covering the opening of the container body 50 against the container body 50 by gripping a part of the lid 60 and a part of the container body 50 together. In the present embodiment, the end of the lid 60 that is closer to the container body holder 40 and the end of the container body 50 that is closer to the container body holder 40 are gripped together by the chuck portions 41, and thus the lid 60 is pressed against the container body 50.

As a result of the pressing of the lid 60 against the container body 50, the lid 60 is tightly fitted on the container body 50.

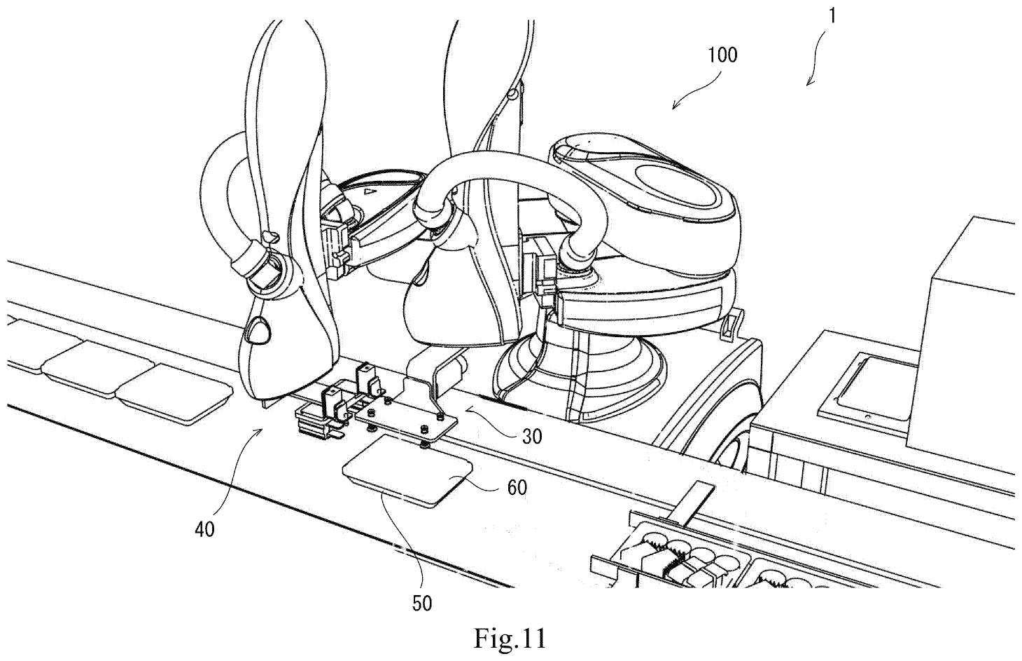

Once the pressing of the lid 60 against the container body 50 is completed, the lid holder 30 and the container body holder 40 move away from the container body 50 and the lid 60 as shown in FIG. 11. FIG. 11 is a perspective view of the lid-closing apparatus 1 in which the lid holder 30 and the container body holder 40 have moved away from the container body 50 and the lid 60.

The foregoing description of the present embodiment is directed to a configuration in which the lid closing is performed by placing the lid 60 in a position where the lid 60 covers the opening of the container body 50, then pressing the lid 60 against the container body 50, and thus fitting the lid 60 tightly on the container body 50. However, the present invention is not limited to the above embodiment. After the lid 60 is placed in the position where the lid 60 covers the opening of the container body 50, the pressing of the lid 60 against the container body 50 need not necessarily be performed if the lid 60 is sufficiently moved by gravity. The lid 60 and the container body 50 may include a mechanism configured to, when the lid 60 covering the opening of the container body 50 is pressed against the container body 50, lock the lid 60 and the container body 50 together in order to keep the opening of the container body 50 closed with the lid 60. When the lid 60 and the container body 50 include the mechanism configured to lock the lid 60 and the container body 50 together, the lid 60 may be pressed against the container body 50 until the lid 60 reaches a position where the lid 60 and the container body 50 are locked together.

The operation of closing the container body 50 with the lid 60 is completed once the lid 60 is placed in a position where the lid 60 covers the opening of the container body 5Q and then the lid 60 and the container body 50 are fitted together.

After the lid-closing operation is completed for one set of the lid 60 and the container body 50, another container body to be subjected to the next lid-closing operation is picked up from the upstream belt conveyor 71 and is moved toward the lid-closing space 90.

The container body 50 and the lid 60 for which the lid-closing operation has been completed move to the downstream belt conveyor 72 from the lid-closing space 90. In the present embodiment, the lid 60 and the container body 50 for which the lid-closing operation has been completed are pushed downstream by the plate member 44 provided in the container body holder 40 and are thus moved toward the downstream belt conveyor 72 from the lid-closing space 90.

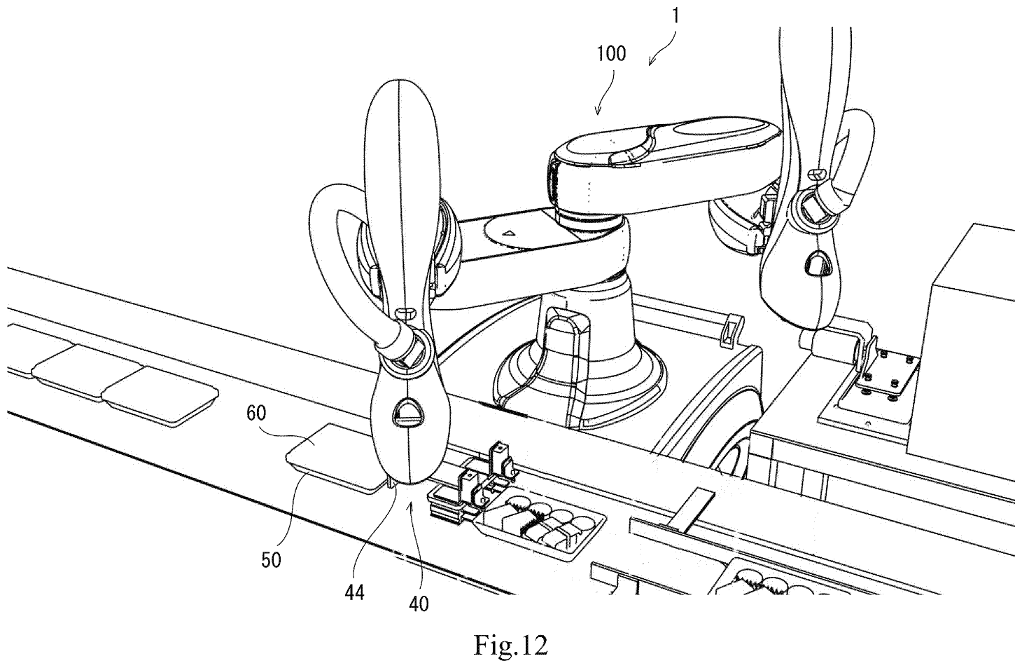

FIG. 12 is a perspective view of the lid-closing apparatus 1 in Which the container body holder 40 gripping the next container body is moving the next container body to the lid-closing space 90 while pushing the container body 50 and the lid 60, for which the lid-closing operation has been completed, toward the downstream belt conveyor 72 by means of the plate member 44.

In FIG. 12, the container body holder 40 is moving the container body to be subjected to the next lid-closing operation toward the lid-closing space 90. At the same time, the lid 60 and container body 50, which have been subjected to the previous lid-closing operation, are moved downstream from the lid-closing space 90 by pushing them with the plate member 44 provided in the container body holder 40.

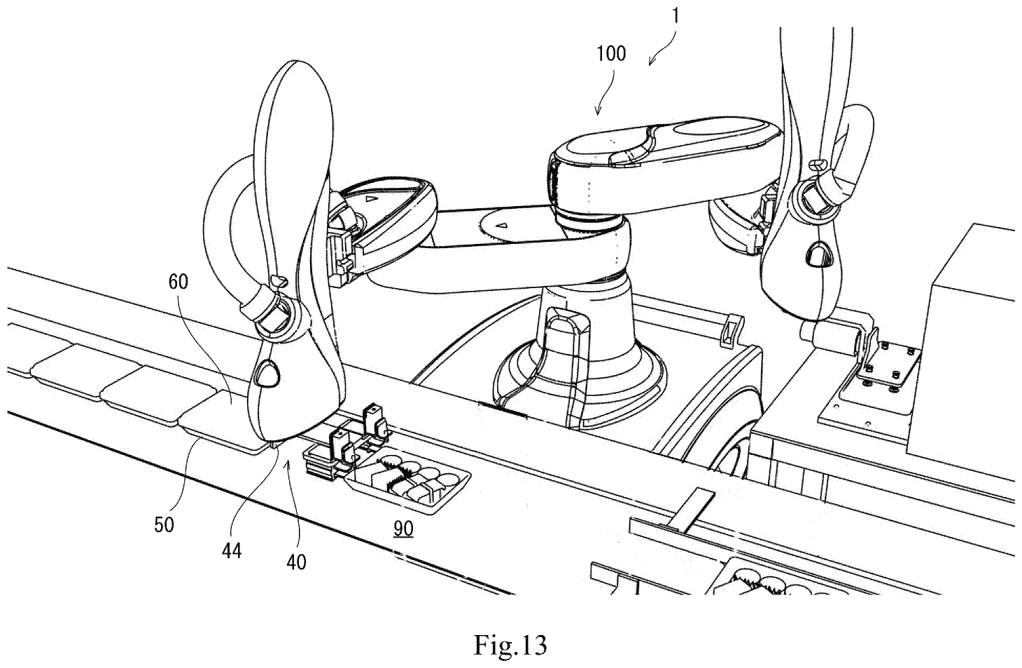

FIG. 13 is a perspective view of the lid-closing apparatus I in which the container body to be subjected to the next lid-closing operation has been placed in the lid-closing space 90. As shown in FIG. 13, at the moment when the container body to be subjected to the next lid-closing operation reaches the lid-closing space 90, the container body 50 and the lid 60 subjected to the previous lid-closing operation have reached the downstream belt conveyor 72. In this manner, the container body holder 40 removes the container body 50 and lid 60 subjected to the previous lid-closing operation from the lid-closing space 90, and moves the container body to be subjected to the next lid-closing operation to the unoccupied lid-closing space 90. Once the container body 50 and lid 60 subjected to the previous lid-closing operation reach the downstream belt conveyor 72, the container body 50 and lid 60 are conveyed downstream by the downstream belt conveyor 72.

In this embodiment, as described above, the operation of closing the container body 50 with the lid 60 includes bringing the tilted lid 60 into contact with the peripheral portion surrounding the opening of the container body 50 and moving the lid 60 by sliding it along the peripheral portion of the container body 50. Thus, the peripheral portion of the container body 50 can be used as a guide for the movement of the lid 60. The operation of closing the container body 50 with the lid 60 therefore does not require the steps of detecting the positional displacement between the container body 50 and the lid 60 and making a correction for the detected displacement. Since the step of detecting the displacement between the container body 50 and the lid 60 is not performed, the need for imaging means such as a camera for detecting the displacement is eliminated. This can result in a reduction in the manufacturing cost of the lid-closing apparatus 1.

The lid 60 is moved by sliding it along the peripheral portion of the container body 50. Thus, once the positioning of the lid 60 in the width direction of the container body 50 (the direction perpendicular to the conveying direction of the container body 50) is made when the lid 60 is brought into partial contact with the peripheral portion of the container body 50, the lid 60 can then be moved using the peripheral portion of the container body 50 as a guide for the movement of the lid 60. Thus, once the positioning of the lid 60 in the width direction is made so as to allow the lid 60 to cover the opening of the container body 50, the lid 60 can be placed in a position where the lid 60 covers the opening of the container body 50 without the need for any further positioning.

Since the peripheral portion of the container body 50 is used as a guide for the movement of the lid 60 in the operation of closing the container body 50 with the lid, high precision is not required of the positioning of the lid 60 to be moved, and control of the movement of the lid 60 is not complicated. Thus, the control structure for controlling the movement of the lid 60 can be simplified.

Since the lid 60 to be brought into contact with the container body 50 is tilted in such a manner that its first end in the conveying direction of the container body 50 faces downward in the gravity direction, the point of contact of the lid 60 with the container body 50 in the conveying direction may be at any site within a certain range. Thus, the position of the lid 60 in the conveying direction of the container body 50 does not need to be precisely defined. That is, high precision is not required of the positioning of the lid 60 in the conveying direction of the container body 50 when the lid 60 is brought into contact with the container body 50.

Since the positioning of the lid 60 involves only the positioning in the width direction, the control structure for controlling the positioning of the lid 60 can be simplified.

In the present embodiment, the upstream belt conveyor 71 is provided with a member for guiding the conveyance of the container body 50. With this member, the position of the container body 50 in the width direction is precisely defined during the conveyance of the container body 50. Additionally, since the lid holder 30 is configured as a component of a robotic arm, precise positioning of the lid holder 30 can easily be achieved. Thus, precise positioning of the lid 60 in the width direction can easily be achieved.

By virtue of the fact that control of the lid holder 30 and the container body holder 40 in the lid-closing operation is easy and thus the control structure for controlling the lid holder 30 and the container body holder 40 is simplified, the control unit 14 responsible for control of the movement of the lid holder 30 and the container body holder 40 does not need to have high performance. This can result in a reduction in the manufacturing cost of the control unit 14.

Additionally, the use of the peripheral portion of the container body 50 as a guide for the movement of the lid 60 can prevent the lid 60 from being displaced away from the opening of the container body 50. Thus, the lid 60 can be accurately moved and placed in a position where the lid 60 covers the opening of the container body 50. This ensures the success of the lid-closing operation.

In the present embodiment, the lid 60 is placed in a position where the lid 60 covers the opening of the container body 50, and then the lid 60 is pressed against the container body 50 to tightly fit the lid 60 on the container body 50. As a result, the container body 50 subjected to the lid-closing operation is securely closed with the lid 60, and consequently detachment of the lid 60 from the container body 50 can be prevented. Therefore, the product contained in the container body 50 is securely protected.

in the present embodiment, the chuck portion 41 of the container body holder 40 is configured to both grip the container body 50 during the movement of the container body 50 and press the lid 60 against the container body 50 after the lid 60 is placed in a position where the lid 60 covers the opening of the container body 50. Since the chuck portion 41 of the container body holder 40 is capable of both gripping the container body 50 and pressing the lid 60 against the container body 50, the gripping of the container body 50 and the pressing of the lid 60 can be accomplished by one component. This eliminates the need for providing the lid-closing apparatus 1 with a component for gripping the container body 50 during the movement of the container body 50 and a different component for pressing the lid 60 against the container body 50, thus simplifying the construction of the lid-closing apparatus 1. The size of the lid-closing apparatus 1 can therefore be reduced. The manufacturing cost of the lid-closing apparatus 1 can also be reduced.

In the embodiment described above, when the lid 60 is brought into contact with the peripheral portion surrounding the opening of the container body 50, the lid 60 to be brought into contact with the peripheral portion surrounding the opening of the container body 50 is tilted in such a manner that its first end (upstream end) in the conveying direction of the container body 50 faces downward in the gravity direction. However, the present invention is not limited to the embodiment described above. When the lid 60 is brought into contact with the container body 50, the lid 60 to be brought into contact with the peripheral portion of the container body 50 may be tilted in such a manner that its second end (downstream end) in the conveying direction of the container body) faces downward in the gravity direction. The lid-closing operation may be performed by sliding the thus tilted lid 60 along the peripheral portion of the container body 50 and placing the lid 60 in a position where the lid 60 covers the opening of the container body 50.

Alternatively, when the lid 60 is brought into contact with the container body 50, the lid 60 to be brought into contact with the peripheral portion of the container body 50 may be tilted in such a manner that one end of the lid 60 in the width direction perpendicular to the conveying direction of the container body 50 faces downward in the gravity direction. As in the previously described case, the lid-closing operation may be performed by sliding the thus tilted lid 60 along the peripheral portion of the container body 50 and placing the lid 60 in a position where the lid 60 covers the opening of the container body 50.

In the embodiment described above, the lid 60 having been placed in a position where the lid 60 covers the opening of the container body 50 is pressed against the container body 50 by causing the chuck portions 41 of the container body holder 40 to grip the lid 60 and the container body 50. However, the present invention is not limited to this configuration. For example, a component other than the lid holder 30 and the container body holder 40 may press the lid 60 against the container body 50, or the lid holder 30 may be configured to press the lid 60 against the container body 50 while holding the lid 60 after completing the movement of the lid 60. Any configuration may be employed as long as the lid 60 having been placed in a position where the lid 60 covers the opening of the container body 50 can be pressed against the container body 50.

### REFERENCE SIGNS LIST

14 Control unit

30 Lid holder

50 Container body

60 Lid

100 Lid-closing apparatus main body

1. A lid-closing apparatus comprising:
a lid holder configured to hold a lid and move the lid; and
a control unit configured to control the holding and movement of the lid by the lid holder, wherein
the control unit performs the control of the holding and movement of the lid by the lid holder in such a manner that:
the lid holder holds the lid;
the lid tilted with a first end thereof facing downward in a gravity direction is brought into partial contact with a first end of a container body having an opening and a peripheral portion surrounding the opening, the first end of the container body being included in the peripheral portion and corresponding to the first end of the lid;
the lid kept in partial contact with the first end of the peripheral portion of the container body is slid to a position where the first end of the lid is a contact portion at which the lid makes contact with the container body and where the first end of the lid is in contact with the first end of the peripheral portion of the container body; and
the container body is closed with the lid covering the opening of the container body.

2. The lid-closing apparatus according to claim 1, wherein the control unit causes the lid to be moved in such a manner that a second end of the lid comes into contact with a second end of the container body once the first end of the lid becomes the contact portion and comes into contact with the first end of the peripheral portion of the container body, the second end of the lid being opposite to the first end of the lid, the second end of the container body being included in the peripheral portion and corresponding to the second end of the lid.

3. The lid-closing apparatus according to claim 1, wherein
the lid holder comprises a holding portion configured to hold a lid and a rotation shaft configured to allow the holding portion to rotate, and
the lid holder is configured to cause the holding portion holding the lid to rotate about the rotation shaft and thereby cause the lid to rotate about the rotation shaft.

4. The lid-closing apparatus according to claim 1, wherein the control unit causes the lid covering the opening of the container body to be moved toward the container body.

5. The lid-closing apparatus according to claim 1, further comprising a container body holder configured to hold the container body and move the container body, wherein
the control unit controls the holding and movement of the container body by the container body holder.

6. The lid-closing apparatus according to claim 5, wherein the container body holder is configured to press the lid covering the opening of the container body against the container body.

7. The lid-closing apparatus according to claim 6, wherein
the container body holder comprises a chuck portion comprising a first member and a second member, the first and second members being configured to move closer to each other, and
the chuck portion is configured to grip a part of the container body between the first and second members and is configured to press the lid covering the opening of the container body against the container body by gripping a part of the lid and a part of the container body together.

8. The lid-closing apparatus according to claim 1, wherein the lid holder is configured as a component of a robotic arm.

9. The lid-closing apparatus according to claim 7, wherein the container body holder is configured as a component of a robotic arm.

10. A lid-closing method for placing a lid in a position where the lid covers an opening of a container body and closing the container body with the lid,
the lid-closing method comprising:
a contacting step of bringing the lid tilted with a first end thereof facing downward in a gravity direction into partial contact with a first end of the container body, the first end of the container body being included in a peripheral portion surrounding the opening, the first end of the container body corresponding to the first end of the lid; and
a sliding step of sliding the lid kept in partial contact with the first end of the peripheral portion of the container body to a position where the first end of the lid is a contact portion at which the lid makes contact with the container body and is in contact with the first end of the peripheral portion of the container body.
